(19) United States
(12) Patent Application Publication
(10) Pub. No.: US 2008/0096183 A1
(43) Pub. Date: Apr. 24, 2008

(54) Instructional exercise mat system

(76) Inventors: Ralph Cotran, Fayetteville, NY (US); Kari Wright, Jamesville, NY (US)

Correspondence Address: LAWRENCE R. FRALEY;Hinman, Howard & Katrell, LLP, 700 Security Mutual Building, 80 Exchange Street, Binghamton, NY, 13902-5250, US

(21) Appl. No.: 11/482,946

(22) Filed: Jul. 10, 2006

(51) Int. Cl. G09B 25/00; A47G 9/06

(52) U.S. Cl. 434/428; 5/420

(57) ABSTRACT

The present invention provides an instructional exercise mat system comprising a mat having instructional indicia for performing at least one group of exercises, the mat including at least one visual display comprising a plurality of illustrations, selected ones of which represent an individual performing at least one of the exercises in the group. The at least one visual display is positioned on a surface of the instructional exercise mat, the system providing all of the information needed by an individual to perform the group(s) of exercises so as to complete at least one exercise routine without the need for additional instruction. Consistent with the present invention, one embodiment may utilize a plurality of such visual displays, and another embodiment may utilize both sides of the mat wherein each side includes one or more such displays. A method and center for performing the method are also provided.

### TECHNICAL FIELD

The present invention relates to the field of exercise mats. More particularly, the present invention relates to an instructional exercise mat system having illustrative visual displays positioned thereon.

### BACKGROUND OF THE INVENTION

Mats used for exercise and other physical activities are known. Although many exercises and other activities for which mats are used can also be done without using a mat, the use of mats has become commonplace as a means to provide added comfort to the individual performing the exercises/activities. Typically, conventional exercise mats are composed of a foam and/or rubber material, and while most conventional exercise mats are rectangular in shape, other various shapes are used as well.

A problem with traditional exercise mats is that they merely serve as exercise accessories. While they may provide added comfort to the individual performing an exercise, unless the individual performing the exercises is very experienced, conventional mats alone do not provide sufficient instructional information to teach an individual how to perform all of the steps of an exercise routine. Therefore, beginners or inexperienced individuals may get comfort from a conventional exercise mat, but they will need additional instruction, via an exercise class, individual instruction, etc., in order to perform an exercise routine. Moreover, in many of the disciplines where the use of exercise mats is commonplace, such as, for example, yoga, abdominal exercises, Pilates, circuit training or stretching, the positioning involved with practicing the exercises make it difficult to watch and follow an instructor while attempting to perform the respective exercises.

More recently, various exercise mats have been developed that include printed indicia on the mats such as lines, grids, handprints, footprints, or other graphical indicia to assist the individual in proper positioning while performing exercises. These mats generally provide visual references regarding the respective position of an individual's feet, hands, and/or body during an exercise. Examples of such mats include U.S. Pat. No. 6,387,013 to Marquez, U.S. Pat. No. 5,645,494 to Dionne et al., U.S. Pat. No. 4,805,913 to Bott, U.S. Pat. No. D355,226 to Wadley; U.S. Pat. No. D393,499 to Brown; U.S. Pat. No. D397,269 to Kawamoto; U.S. Pat. No. D291,586 to Bourret, U.S. patent application Ser. No. 2005/0192158 A1 by Edwards, U.S. patent application Ser. No. 2004/0229731 by Mitchell, U.S. patent application Ser. No. 2004/0214692 A1 by Koeing, U.S. patent application Ser. No. 2002/0142888 by Marques, U.S. patent application Ser. No. 2002/0098947 A1 by Brown, and U.S. patent application Ser. No. 2001/0034288 A1 by Howlett-Campanella. These mats, however, do not completely adequately instruct an individual how to perform all of the exercises necessary to satisfactorily complete a desired exercise routine. Instead they merely provide guidance on where to position one's body when performing an exercise already known to the individual, or assistance to an individual attempting to correctly follow outside instructions regarding an exercise. Accordingly, these mats still require the individual to either have experience with the exercises or to have some form of outside instruction on what the exercises are and how to perform them.

In view of the above, a need exists for an instructional exercise mat with illustrative visual displays thereon, which will allow even beginners and inexperienced individuals to perform exercises without outside instruction. It is believed that such an invention will represent a significant advancement in the art.

### OBJECTS AND SUMMARY OF THE INVENTION

It is, therefore, a primary object of the present invention to enhance the field of exercise mats by providing an instructional exercise mat having the advantageous features taught herein.

It is another object of the invention to provide an instructional exercise mat system capable of providing an individual with all the instruction necessary to perform a group of exercises without necessitating outside instruction or substantial experience.

It is still another object of the invention to provide an instructional exercise mat system capable of providing an individual with all the instruction necessary to perform an exercise routine without the need for outside instruction or experience.

It is yet another object of the invention to provide a method of enabling an individual to perform an exercise routine utilizing an instructional exercise mat and thus benefiting from the several advantageous features thereof.

Consistent with one embodiment of the present invention, an instructional exercise mat system is provided comprising a mat having a first surface; and at least one visual display positioned on said first surface of said mat and including a plurality of illustrations, each of said illustrations representing an individual performing at least one of the steps of at least one of a first group of exercises such that said at least one visual display provides substantially all of the instructional information needed by an individual utilizing said instructional exercise mat system to perform at least one exercise routine without the need for additional instruction.

In accordance with another embodiment, a method of providing an individual with instructional information sufficient to enable said individual to perform at least one exercise routine is provided, said method comprising providing an individual with a location in which said individual may perform at least one exercise routine; providing said individual with an instructional exercise mat system useable at said location and including a mat with a first surface and at least one visual display positioned on said first surface and including a plurality of illustrations, each of said illustrations representing an individual perfomming at least one of the steps of at least one of a first group of exercises such that said at least one visual display provides substantially all of the instructional information needed by said individual utilizing said instructional exercise mat system to perform said at least one exercise routine without the need for additional instruction; and permitting said individual to use said instructional exercise mat system at said location such that said individual may perform said at least one of said first group of said exercises.

According to yet another embodiment of the present invention, a health and/or fitness center is provided comprising a location adapted for having individuals perform a plurality of exercise routines; and a plurality of instructional exercise mat systems, useable at said location, each of said instructional exercise mat systems including a mat with a first surface and at least one visual display positioned on said first surface and including a plurality of illustrations, each of said illustrations representing an individual performing at least one of the steps of at least one of a first group of exercises, such that said at least one visual display provides substantially all of the instructional information needed by said individual utilizing said instructional exercise mat system to perform at least one exercise routine without the need for additional instruction.

It is understood that both the foregoing general description and the following detailed description are exemplary and explanatory only and are not restrictive of the embodiments of the invention as described and claimed. The description of aspects, features, and/or advantages of particular embodiments of the present invention are not intended and should not be construed to provide any limitations on the present claimed invention.

### BRIEF DESCRIPTION OF THE DRAWINGS

The accompanying drawings, which are incorporated in and constitute part of the disclosure, illustrate various embodiments and aspects of the present invention. In the drawings:

FIG. 1 is a schematic diagram of an exemplary instructional exercise mat system in accordance with one embodiment the present invention;

FIG. 2 is a schematic diagram of an exemplary instructional exercise mat system in accordance with another embodiment of the present invention;

FIG. 3 is an illustrative example of one embodiment of the present invention;

FIG. 4 is an illustrative example of another embodiment of the present invention; and

FIG. 5 is a flowchart illustrating a method of utilizing the present invention.

### DETAILED DESCRIPTION

For a better understanding of the present invention, together with other and further objects, advantages and capabilities thereof, reference is made to the following disclosure and appended claims in connection with the above-described drawings. It is understood that, in the absence of a contrary representation, like numerals in different drawings indicate like elements. The implementations in the following description do not represent all implementations consistent with the present claimed invention. Instead, they are merely examples of systems and methods consistent with the invention.

“Exercise routine” as used herein is meant to include a plurality of individual exercises of at least one group of exercises intended to accomplish desired results, e.g. strengthened abdominal muscles. Such a routine may be comprised of more than one group of such exercises.

The term “health and/or fitness center” as used herein is meant to include any location where an individual may perform a series of exercises or exercise routines, typically using one or more items of equipment.

“Illustration” as used herein is meant to include any form of visual representation including photographs, pictures, images, graphics, diagrams, caricatures, etc.

The term “instructional indicia” as used herein is meant to include any form of instructional information, including, but not limited to, photographs, pictures, images, graphics, diagrams, caricatures, written instructions, written descriptions, etc.

“Media component” as used herein is meant to include any form of electronic media, including, but not limited to, videos in any format (VHS, DVD, etc.), compact discs (CD's), computer programs, etc.

The term “video” as used herein is meant to include any and all video formats and storage devices, including but not limited to VHS and DVD.

“Visual display” as used herein shall mean any visual representation of any form of instructional indicia.

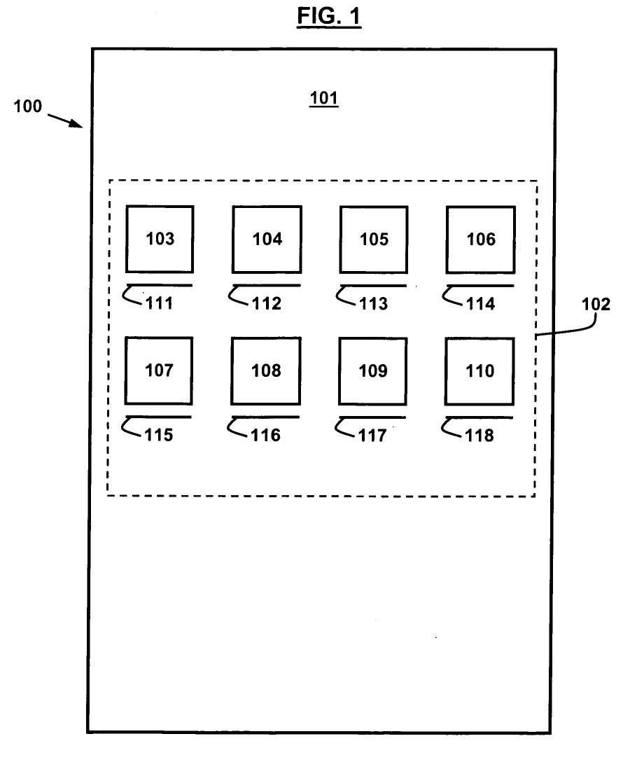

Now referring to the drawings, FIG. 1 is a schematic diagram of an exemplary instructional exercise mat system in accordance with one embodiment of the present invention. The instructional exercise mat system represented in FIG. 1 comprises a mat 100 having a first surface 101 and having a first visual display 102 positioned on said first surface 101. The mat 100 may be fabricated from any well-known material, and may have any one or more properties or features (e.g. flexibility or moisture absorption) commonly associated with exercise mats as established in the art and known to artisans. For example, in one embodiment the mat may be fabricated from rubber and rubber synthetics. Alternative embodiments may use any combination of other rubber blends, various types of foam, such as ethylene vinyl acetate (EVA), and/or various types of plastic, such as polyvinyl chloride (PVC). Furthermore, although the mat 100 in FIG. 1 is rectangular in shape, one skilled in the art would realize that various other shapes could be used consistent with the present invention. FIG. 1 is merely one embodiment of the invention; accordingly, the depiction of mat 100 as being rectangular in shape is in no way intended to limit the scope of the invention.

As illustrated in FIG. 1, said first visual display 102 comprises a plurality of illustrations 103-110. The plurality of illustrations 103-110 in visual display 102 may be related so as to represent various positions or steps involved in a first group of exercises designed to accomplish a specific exercise routine. For example, an instructional exercise mat consistent with the present invention could provide an individual with a complete workout for any discipline, general exercise regimen, or muscle group. However, it is not necessary to the present invention that said plurality of illustrations 103-110 be directly related, only to the extent that these provide all of the instructional indicia (information) intended to complete a desired exercise routine. For example, an individual may desire to strengthen his/her abdominal muscles while doing so only in a beginner's mode, as compared to one who seeks to provide such strengthening but who has had extensive experience and thus may desire more advanced exercises. Moreover, the embodiment represented in FIG. 1 further includes descriptions 111-118, which correspond respectively to illustrations 103-110. Said descriptions may describe the exercise represented in the corresponding illustration. For example, if illustration 103 represented an individual performing a roundhouse kick, description 111 could read “Roundhouse Kick.” The embodiment represented in FIG. 1 includes a plurality of photographs 103-110, each showing a person properly illustrating at least one of the steps of at least one of a group of exercises and thus completely shows the mat user all he/she needs to know to accomplish each particular exercise in a safe and effective manner. Further, the illustrations, descriptions and other instructional indicia positioned on the mat are printed on the mat using any well-known printing method. For example, in one embodiment a large format digital printer may be used to digitally transfer the illustrations, descriptions, and other instructional indicia onto the mat. Alternative embodiments may transfer the illustrations, descriptions and other instructional indicia using a silk-screening process or other form of screen-printing, pad printing, or dye sublimation.

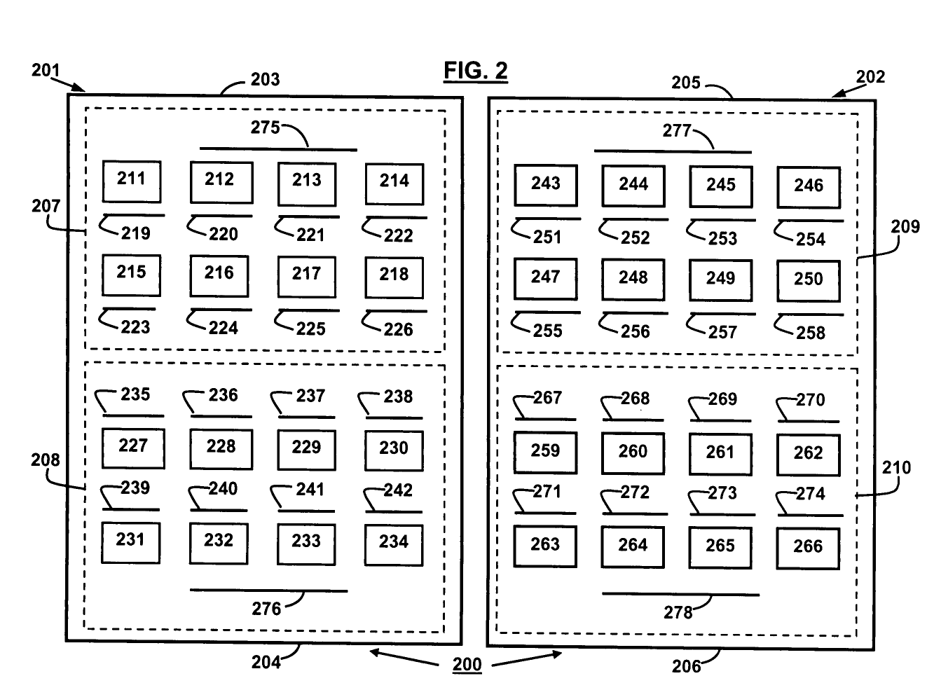

FIG. 2 is a schematic diagram of an exemplary instructional exercise mat system in accordance with another embodiment of the present invention. The instructional exercise mat system represented in FIG. 2 comprises a mat 200 having a first surface 201 and a second surface 202. As illustrated in FIG. 2, the first surface 201 has a first end 203 and a second end 204. Moreover, the second surface 202 also has a first end 205 and a second end 206. Regarding the first surface 201, a first visual display 207 is positioned on the first end 203 of the first surface 201. Further, a second visual display 208 is positioned on the second end 204 of the first surface 203. Similar to first visual display 207, second visual display 208 comprises a plurality of illustrations 227-234 and respective corresponding descriptions 235-242. Regarding the second surface 202, a third visual display 209 is positioned on the first end 205 of said second surface 202. Said third visual display comprises a plurality of illustrations 243-250 and respective descriptions 251-258. In the embodiment illustrated in FIG. 2, the second surface 202 also includes a fourth visual display 210, which is positioned on the second end 206 of the second surface 202. Said fourth visual display comprises a plurality of illustrations 259-266 and respective corresponding descriptions 267-274.

In one embodiment, each of the first, second, third, and fourth visual displays include directly related exercises, and may be titled accordingly via titles 275, 276, 277, and 278. Moreover, in one embodiment the first, second, third, and fourth visual displays are also directly related, whether by a particular discipline (e.g. yoga, karate, Pilates, etc.), or a particular muscle or group of muscles (e.g. abdominal muscles, leg muscles, arm muscles, etc.). In one exemplary embodiment, the first, second, third and fourth visual displays may represent four different groups of exercises that are a part of a certain discipline (routine). For example, if the instructional exercise mat was designed to instruct an individual in karate, the title 275 of the first visual display 207 may be “basics (kihon),” the title 276 of the second visual display 208 may be “forms (kata),” the title 277 of the third visual display 209 may be “sparring (kumite),” and the title 278 of the fourth visual display 210 may be “grappling (katame).” In another exemplary embodiment, the first, second, third, and fourth visual displays may represent four different types of exercises for a particular group of muscles. For example, if the instructional exercise mat was designed to instruct the individual in upper body exercise, the title 275 of the first visual display 207 may be “biceps,” the title 276 of the second visual display 208 may be “triceps,” the title 277 of the third visual display 209 may be “chest,” and the title 278 of the fourth visual display 210 may be “shoulders.” Each of the illustrations in these displays will clearly show a person performing the appropriate step to accomplish the described regimen. In yet another exemplary embodiment, the first, second, third, and fourth visual displays may represent four different skill levels for a particular type of exercise. For example, the title 275 of the first visual display 207 may be “beginner,” the title 276 of the second visual display 208 may be “intermediate,” the title 277 of the third visual display 209 may be “advanced,” and the title 278 of the fourth visual display 210 may be “expert.” The embodiments described above are merely exemplary and are not intended to limit the present invention in any way. It is thus understood that several combinations and permutations of exercises and exercise groups are possible using the new and unique teachings of this invention.

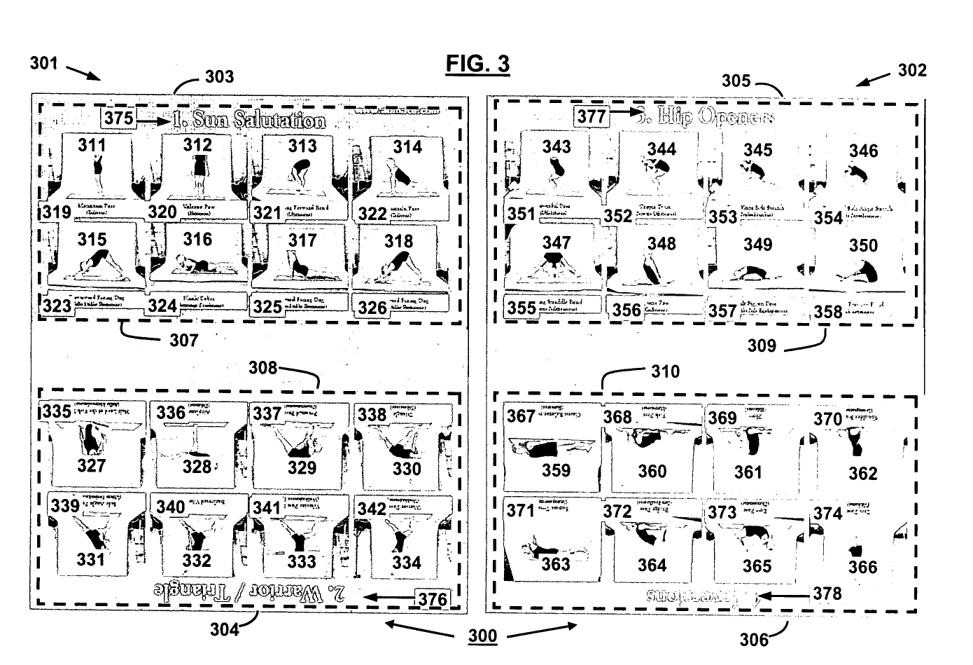

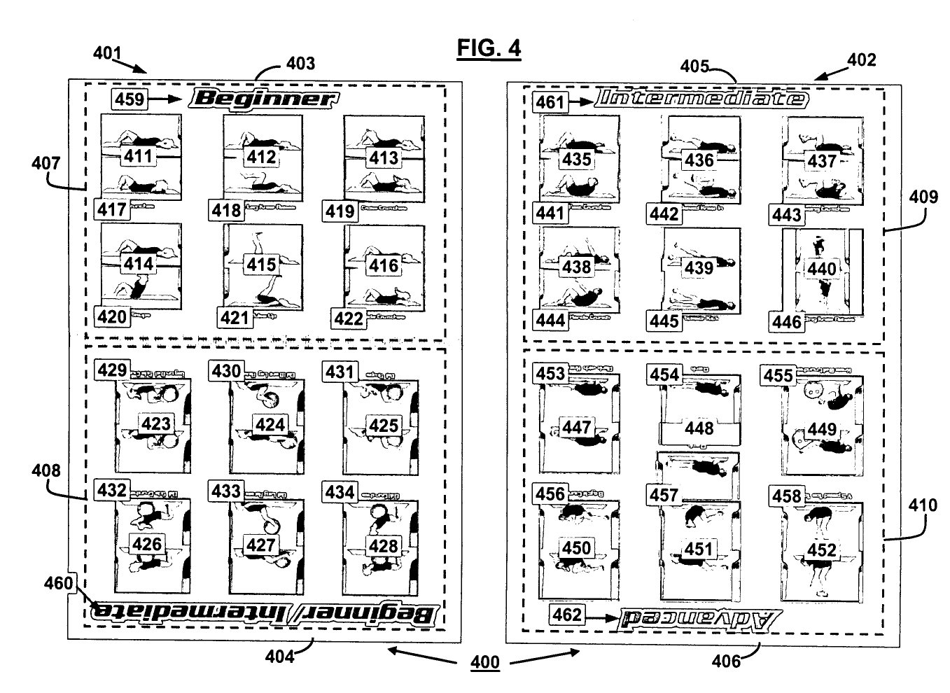

As shown in FIG. 2, one embodiment utilizes both the first surface 201 and the second surface 202 of mat 200. Moreover, this embodiment comprises a first visual display 207, a second visual display 208, a third visual display 209, and a fourth visual display 210. Furthermore, the embodiment shown in FIG. 2 comprises a plurality of visual displays 207, 208, 209, and 210 and a plurality of illustrations 211-218, 227-231, 243-250, and 259-266. FIG. 2, however, is merely one embodiment of the present invention, and those skilled in the art would realize that other embodiments consistent with the present invention may include instructional exercise mats that utilize only a single side of the mat, instructional exercise mats that contain only a single visual display or a single illustration positioned thereon, as well as instructional exercise mats that do not include written descriptions or full exercise routines. In addition, while the embodiment shown in FIG. 2 shows visual displays 207, 208, 209, and 210 being positioned at ends 203, 204, 205, and 206 of the first 201 and second 202 surfaces, in other embodiments the visual display(s) may be positioned elsewhere. In the embodiment shown in FIG. 2, the positioning of visual displays 207, 208, 209, and 210 may be efficient by allowing for the inclusion of a large amount of instructional indicia through the use of both sides of mat 200 and both ends of each side. However, if the mat 200 were circular in shape, for example, perhaps the most operative positioning of the visual display(s) would be all around the edge of the circle so that an individual could stand or sit in the center of the mat and perform exercises. Moreover, even on a rectangular mat, if the exercises represented in the visual display(s) necessitated lying on one's side, for example, perhaps the most operative positioning of the visual display(s) would be in a single line alongside the long edges of the rectangle. Accordingly, the embodiment shown in FIG. 2 is merely one embodiment of the present invention, and those skilled in the art would realize that various other embodiments would also be consistent with the present invention. Although the numbers in FIG. 2 are shown in one orientation, this is not meant to limit the invention because in at least one embodiment of the invention, the lower displays 208 and 210 may be inverted with respect to the upper displays 207 and 209, for enhanced illustration purposes (ease of viewing by the mat operator who will like position himself/herself in the mat center approximately between both displays). This inverted relationship is better seen in the embodiments of FIGS. 3 and 4 below.

FIG. 3 is an illustrative example of one embodiment of the present invention. FIG. 3 shows an instructional exercise mat system for use in instructing an individual in the practice of yoga. Similar to FIG. 2, the mat 300 in FIG. 3 has both a first surface 301 and a second surface 302. The first surface 301 has a first end 303 and a second end 304, while the second surface 302 has a first end 305 and a second end 306. Regarding the first surface 301, a first visual display 307 is positioned on the first end 303 of the first surface 301. Said first visual display 307 comprises a plurality of illustrations 311-318 and respective corresponding descriptions 319-326. Further, a second visual display 308 is positioned on the second end 304 of the first surface 303. Similar to first visual display 307, second visual display 308 comprises a plurality of illustrations 327-334 and respective corresponding descriptions 335-342. Regarding the second surface 302, a third visual display 309 is positioned on the first end 305 of said second surface 302. Said third visual display comprises a plurality of illustrations 343-350 and respective descriptions 351-358. In the embodiment illustrated in FIG. 3, the second surface 302 also includes a fourth visual display 310, which is positioned on the second end 306 of the second surface 302. Said fourth visual display comprises a plurality of illustrations 359-366 and respective corresponding descriptions 367-374.

In FIG. 3, the visual displays 307, 308, 309, and 310 represent examples of four different types of yoga exercises. For example, the title 375 of the first visual display 307, as shown, may be “Sun Salutation,” the title 376 of the second visual display 308 may be “Warrior/Triangle,” the title 377 of the third visual display 309 may be “Hip Openers,” and the title 378 of the fourth visual display 310 may be “Inversions.” As can be seen in FIG. 3, in one embodiment of the present invention, the illustrations 311-318, 327-334, 343-350, and 367-374 represented in the various visual displays 307, 308, 309, and 310, respectively, may be photographs. In embodiments such as the one shown in FIG. 3 wherein the illustrations are photographs, the photographs may be black and white in one embodiment or in full color in an alternative embodiment. Moreover, FIG. 3 is only one embodiment of the present invention and various other embodiments may include illustrations that contain any form of pictures, images, graphics, diagrams, caricatures, etc., whether in black and white or in full color.

FIG. 4 is an illustrative example of another embodiment of the present invention. FIG. 4 shows an instructional exercise mat system for use in instructing an individual in the practice of abdominal exercises. Similar to FIGS. 2 AND 3, the mat 400 in FIG. 4 has both a first surface 401 and a second surface 402. The first surface 401 has a first end 403 and a second end 404, while the second surface 402 has a first end 405 and a second end 406. Regarding the first surface 401, a first visual display 407 is positioned on the first end 403 of the first surface 401. Said first visual display 407 comprises a plurality of illustrations 411-416 and respective corresponding descriptions 417-422. Further, a second visual display 408 is positioned on the second end 404 of the first surface 403. Similar to first visual display 407, second visual display 408 comprises a plurality of illustrations 423-428 and respective corresponding descriptions 429-434. Regarding the second surface 402, a third visual display 409 is positioned on the first end 405 of said second surface 402. Said third visual display comprises a plurality of illustrations 435-440 and respective descriptions 441-446. In the embodiment illustrated in FIG. 4, the second surface 402 also includes a fourth visual display 410, which is positioned on the second end 406 of the second surface 402. Said fourth visual display comprises a plurality of illustrations 447-452 and respective corresponding descriptions 453-458.

In FIG. 4, the visual displays 407, 408, 409, and 410 represent examples of abdominal muscle exercises for four different skill levels. The title 459 of the first visual display 407, as shown, may be “Beginner,” the title 360 of the second visual display 408 may be “Beginner/Intermediate,” the title 461 of the third visual display 409 may be “Intermediate,” and the title 462 of the fourth visual display 410 may be “Advanced.” The consecutive visual displays (first, second, third, fourth) represent abdominal exercises of increasing difficulty. Moreover, as illustrated in FIG. 4, each illustration (e.g. 411) includes two different illustrations to provide added instruction for an individual trying to perform the exercises included on the instructional exercise mat 400. Such a variation is consistent with the present invention.

While FIGS. 3 and 4 represent yoga and abdominal exercises, respectively, these embodiments are merely exemplary and should in no way be construed to limit the present invention. Instructional exercise mats consistent with the teachings of the present invention may be developed for any discipline, including, but not limited to, yoga, Pilates, kickboxing, circuit training, running, aerobics, weight training, tae-bo, karate, tae kwon do, judo, and various other martial arts and exercise disciplines. Moreover, instructional exercise mats consistent with the teachings of the present invention may be developed for any muscle or muscle group, including, but not limited to, abdominals, legs, arms, chest, shoulders, back, etc. Furthermore, instructional exercise mats consistent with the present invention may be developed for any other generalized exercise regimen, including, but not limited to, stretching, toning, weight lifting, etc. Finally, instructional exercise mats consistent with the present invention may be developed for specific age or gender groups, including, but not limited to toddlers, children, teens, young adults, middle-aged individuals, elderly individuals, men and women. It is also within the scope of the present invention that any of these categories could overlap, for example, different instructional exercise mats for a particular discipline or generalized exercise regimen could be developed for different age groups or genders. Following the yoga example provided in FIG. 3, consistent with the present invention, different instructional yoga mats could be made for kids, teens, or adults, as well as for men and women.

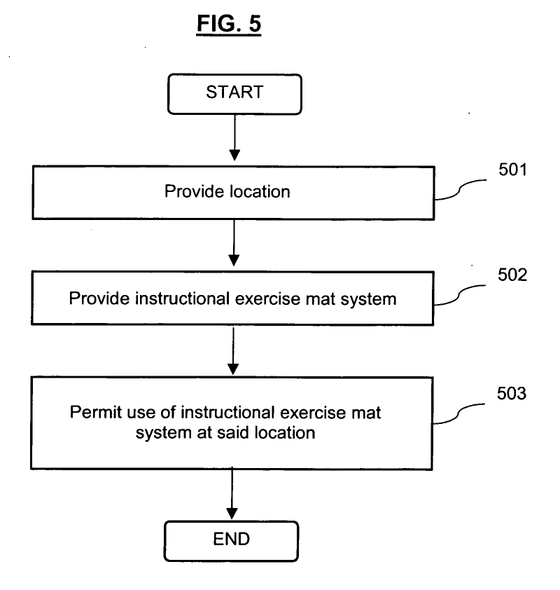

FIG. 5 is a flowchart illustrating a method of utilizing the present invention. The method shown in FIG. 5 is a method of providing an individual with instructional information sufficient to enable said individual to perform at least one group of exercises needed to complete a desired exercise routine without the need for additional instruction. First, an individual is provided with a location in which said individual may perform at least one exercise routine (step 501). Said location may be a health and/or fitness center, such as Gold's Gym or Bailey Total Fitness. Next, said individual is provided with an instructional exercise mat system useable at said location and including a mat with a first surface and a first visual display positioned on said first surface and including a plurality of illustrations, each of said illustrations representing an individual performing one of the steps of said at least one exercise routine such that said first visual display provides substantially all of the instructional information needed by said individual utilizing said instructional exercise mat system to perform said at least one exercise routine without the need for additional instruction (step 502). Finally, said individual is permitted to use said instructional exercise mat system at said location such that said individual may perform said at least one exercise routine (step 503).

Although the invention described herein has the object of providing an instructional exercise mat system that provides an individual with all the instruction necessary to perform an exercise or various exercises without the need for outside instruction, media components such as videos (VHS and/or DVD) or CD's may be marketed in conjunction with said mats to further enhance the individual's experience when using the mat. Such media components are not necessary for the present invention to meet its objectives, however, nothing herein is meant to exclude the possibility of including any type of media component in an instructional exercise mat system developed in accordance with the teachings of the present invention.

Thus there has been shown and described various embodiments of an instructional exercise mat system capable of providing an individual with all the instruction necessary to perform an exercise routine without the need for outside instruction or experience. The present invention is capable of being produced in a relatively inexpensive manner, and would therefore be relatively inexpensive to consumers and could be readily available to the consumer public in a wide number and variety of stores, health and/or fitness centers, or other facilities.

While there have been shown and described particular embodiments of the invention, it will be obvious to those skilled in the art that various changes and modifications may be made therein without departing from the scope of the invention as defined by the appended claims. Accordingly, the foregoing description of possible embodiments consistent with the present invention does not represent a comprehensive list of all such embodiments, nor does it represent all variations of the embodiments described. The description of only some embodiments should not be construed as an intent to exclude other embodiments or implementations. Artisans will understand how to implement the invention in the appended claims in many other ways, using equivalents and alternatives that do not depart from the scope of the following claims. Moreover, unless indicated to the contrary in the preceding description, none of the components described in the implementations are essential to the invention.

What is claimed is:

1. An instructional exercise mat system comprising:
a mat having a first surface; and
at least one visual display positioned on said first surface of said mat and including a plurality of illustrations, each of said illustrations representing an individual performing at least one of the steps of at least one of a first group of exercises such that said at least one visual display provides substantially all of the instructional information needed by an individual utilizing said instructional exercise mat system to perform at least one exercise routine without the need for additional instruction.

2. The instructional exercise mat system of claim 1 wherein selected ones of said illustrations are photographs.

3. The instructional exercise mat system of claim 2 wherein selected ones of said illustrations in said at least one visual display further include a written description adjacent a respective one of said illustrations.

4. The instructional exercise mat system of claim 1 wherein the number of visual displays is two, the second of said visual displays also positioned on said first surface of said mat and including a plurality of illustrations, each of said illustrations representing an individual performing at least one of the steps of at least one of a second group of exercises to perform said at least one exercise routine.

5. The instructional exercise mat system of claim 4 wherein selected ones of said illustrations in said second of said visual displays are photographs.

6. The instructional exercise mat system of claim 5 wherein selected ones of said illustrations in said second of said visual displays further include a written description adjacent a respective one of said illustrations.

7. The instructional exercise mat system of claim 4 wherein said mat includes first and second ends, one of said visual displays being positioned on said first end of said mat and the second of said visual displays being positioned on said second end of said mat.

8. The instructional exercise mat system of claim 4 wherein said mat further includes a second surface, said system further including a third visual display positioned on said second surface and including a plurality of illustrations, each of said illustrations representing an individual performing at least one of the steps of at least one of a third group of exercises to perform said at least one exercise routine.

9. The instructional exercise mat system of claim 8 wherein selected ones of said illustrations of said third visual display are photographs.

10. The instructional exercise mat system of claim 9 wherein selected ones of said illustrations of said third visual display further include a written description adjacent a respective one of said illustrations.

11. The instructional exercise mat system of claim 8 further including a fourth visual display also positioned on said second surface of said mat and including a plurality of illustrations, each of said illustrations representing an individual performing at least one the steps of at least one of a fourth group of exercises to perform said at least one exercise routine.

12. The instructional exercise mat system of claim 11 wherein selected ones of said illustrations of said fourth visual display are photographs.

13. The instructional exercise mat system of claim 12 wherein selected ones of said illustrations of said fourth visual display further include a written description adjacent a respective one of said illustrations.

14. The instructional exercise mat system of claim 11 wherein said first surface of said mat includes first and second ends, said at least one and said second of said visual displays being positioned on said first and second ends of said first surface, respectively, and wherein said second surface of said mat includes first and second ends, said third and fourth visual displays being positioned on said first and second ends of said second surface, respectively.

15. The instructional exercise mat system of claim 1 wherein said mat further includes a second surface, said system further including at least a second visual display positioned on said second surface and including a plurality of illustrations, each of said illustrations representing an individual performing at least one of a second group of exercises to perform said at least one exercise routine.

16. The instructional exercise mat system of claim 15 wherein selected ones of said illustrations of said second visual display are photographs.

17. The instructional exercise mat system of claim 16 wherein selected ones of said illustrations of said second visual display further include a written description adjacent a respective one of said illustrations.

18. A method of providing an individual with instructional information sufficient to enable said individual to perform at least one exercise routine, said method comprising:
providing an individual with a location in which said individual may perform at least one exercise routine;
providing said individual with an instructional exercise mat system useable at said location and including a mat with a first surface and at least one visual display positioned on said first surface and including a plurality of illustrations, each of said illustrations representing an individual performing at least one of the steps of at least one of a first group of exercises such that said at least one visual display provides substantially all of the instructional information needed by said individual utilizing said instructional exercise mat system to perform said at least one exercise routine without the need for additional instruction; and
permitting said individual to use said instructional exercise mat system at said location such that said individual may perform said at least one of said first group of said exercises.

19. The method of claim 11 wherein said providing of said location comprises providing a health and/or fitness center.

20. A health and/or fitness center comprising:
a location adapted for having individuals perform a plurality of exercise routines; and
a plurality of instructional exercise mat systems, useable at said location, each of said instructional exercise mat systems including a mat with a first surface and at least one visual display positioned on said first surface and including a plurality of illustrations, each of said illustrations representing an individual performing at least one of the steps of at least one of a first group of exercises, such that said at least one visual display provides substantially all of the instructional information needed by said individual utilizing said instructional exercise mat system to perform at least one exercise routine without the need for additional instruction.
